(19) United States
(12) Patent Application Publication
(10) Pub. No.: US 2005/0094488 A1
(43) Pub. Date: May 5, 2005

(54) Mixer

(75) Inventor: Nicolaas Van Der Plas, Oldenzaal (NL)

Correspondence Address: DARBY & DARBY P.C., P. O. BOX 5257, NEW YORK, NY, 10150-5257, US

(73) Assignee: Trioliet Mullos B.V., AC Oldenzaal (NL)

(21) Appl. No.: 10/968,856

(22) Filed: Oct. 18, 2004

(30) Foreign Application Priority Data
Oct. 16, 2003 (DE) 203 15 947.0

(51) Int. Cl. B01F 7/24

(52) U.S. Cl. 366/297; 366/307; 366/314; 366/603

(57) ABSTRACT

A mixer which has a mixing chamber which can be filled from above and which has a wall, a bottom and at least two rotating, drivable mixing tools arranged inside the mixing chamber, each covering an operating circle (A) projected on the bottom. In a gusset regions between the two operating circles (A), a guide device is provided that leaves a transfer opening. Dead corners are avoided by having the wall at the transition to the bottom follow the curve of the respective operating circle (A) through into the gusset region between the two operating circles (A), so that the wall itself, without or with an extension, forms the respective guide device.

### FIELD OF THE INVENTION

The invention relates to a mixer, in particular a feed mixing truck.

### BACKGROUND OF THE INVENTION

This type of mixer is known from EP 1 175 828 A1. The known mixer exhibits a container, bounded by a wall, with a mixing chamber arranged in the interior. The mixing chamber contains a bottom from which the wall extends upwards and outwards at least in the front and rear parts in the direction of travel of the feed mixing truck. The side regions of the wall viewed in the direction of travel are flattened so that the feed mixing truck can also negotiate narrow stable alleys. Inside the mixing chamber two mixing tools—in the illustrated embodiment the usual mixing screws—are arranged, each rotating about a vertical axis. The mixing tools each cover an operating circle on the bottom, whereby the operating circles of both mixing screws do not quite overlap. Each mixing screw conveys material centrally upwards, whereupon material flows downwards again along the sidewalls. Between the two mixing screws an outlet is provided through which the material to be mixed, i.e. the feed, is transported from the region of one mixing screw into the region of the adjacent mixing screw. This outlet is flanked on both sides by tapered guide devices inserted in the mixing chamber and by means of the sloped sides of which the mix material flowing down from above is partly diverted to the other mixing screw, thereby improving the mixing effect. Inserted guide devices are expensive constructively and, with the provision of adequately large, straight lateral slides for discharging, cannot prevent the formation of dead corners in which feed is left remaining.

In DE 203 14 002 U, which has not been subject to prior publication, a feed mixing truck has already been described, whose wall in the region of the bottom follows the curve of the operating circle. This feed mixing truck is furthermore provided with a side discharge opening, which can be closed with a slide. Also the slide follows the curvature of the operating circle in its lower region, so that here no dead corners remain. The known mixing truck is however just equipped with a single mixing screw rotating about a vertical axis, which significantly simplifies construction.

### BRIEF DESCRIPTIONS OF THE INVENTION

The object of the invention is therefore to further develop a mixer of the type mentioned, such that “dead corners” can be prevented in a constructively simple manner also with mixers formed with a number of mixing tools.

With the design according to the invention the wall follows the curve of the operating area through into the gusset region, so that “dead corners” can be reliably prevented. In a constructively simple manner the guide device can also therefore be formed by the wall with or without extension.

Due to the design according to the invention a curved slide can be used even with a mixer with a number of mixing tools, as described for the prevention of dead corners in DE 203 14 002 U1, whereby also here the guidance of the slide can be arranged at curved regions of the wall, so that it is easy to open.

The guide device can be formed, preferably solely by the wall, in the form of a symmetrical guide taper, but it can also be formed as an asymmetrical guide cone, preferably by a combination of the wall and an extension.

The indentation forming on the outer side of the mixing chamber by the drawn-in wall in the gusset region is located at a point which normally is provided with flattening. Also here the construction is simplified, because additional applied flattening is no longer necessary.

This indentation can be optionally covered from outside by a panel construction.

The construction can be further simplified if flattened areas which are assigned to both operating circles are joined together by a web.

The design of the wall occurs preferably through an imaginary penetration or intersection of at least two curved single walls, which are each curved around an operating circle, which run from there outwards and upwards to form an enlarged filling opening with respect to the bottom and which are provided with a side flattening, whereby the single walls are composed penetrating or cutting one another, so that the respective operating circles do not quite overlap and a guide device forms in the respective gusset area through the wall with or without extension, leaving the passage opening between the two operating circuits free, the said guide device flanking the passage opening.

### BRIEF DESCRIPTION OF THE DRAWINGS

Embodiments of the invention are explained in the following based on the drawings. The following are shown:

FIG. 1 a first embodiment of the invention in perspective plan view,

FIG. 2 a plan view onto the embodiment according to FIG. 1 in partial section along the line II-II,

FIG. 3A, 3B the constructional principle according to this invention,

FIG. 4 a representation similar to FIG. 1 of another embodiment of the invention, and

FIG. 5 a representation similar to FIG. 1 of a third embodiment of the invention.

### DETAILED DESCRIPTION OF THE INVENTION

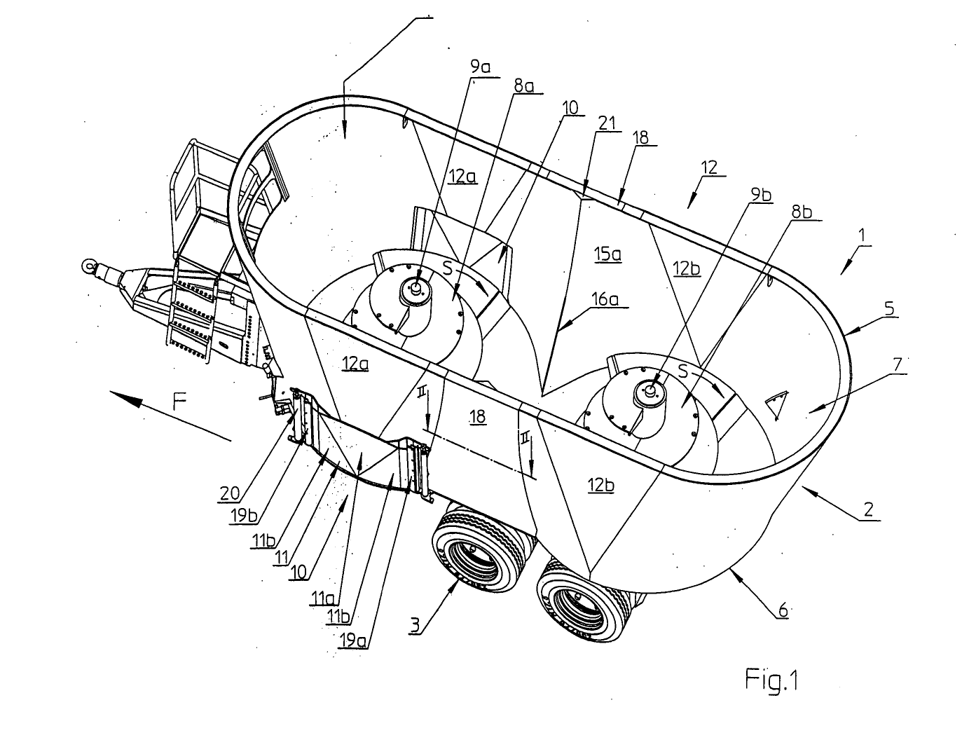

In FIG. 1 a mixer 1 can be seen which is formed in the illustrated embodiment as a mixing truck for animal feed. The mixer 1 contains a mixing container 2, which is attached to a chassis 3 and which with the aid of a towing vehicle, such as for example a tractor or similar vehicle, can be moved in the direction of travel F also in a stable alley or similar location, e.g. using a tow bar. The container 2 contains a mixing chamber 4 which is bounded by a flat wall 5 of metal sheet or similar material and a bottom 6. The container 2 is provided with an upper opening 7, through which the mixed material, i.e. in particular the feed, can be introduced into the mixing chamber 4. In the embodiment illustrated the filling opening 7 is completely open. However, it could also be fully or partly covered by a cover.

In the interior of the mixing chamber 4 two mixing tools 8a and 8b are provided, arranged one behind the other in the direction of travel F. The mixing tools 8a, 8b rotate respectively about an axis 9a, 9b which runs perpendicular to the bottom 6. The direction of rotation of the two mixing tools 8a, 8b is the same in the illustrated embodiment and takes place in the direction of the arrow S. Consequently the mixing tools 8a, 8b cover respectively an operating circle A on the bottom 6. In the illustrated embodiment the mixing tools 8a, 8b are vertical screws, as preferred in many designs of feed mixers. The two rotating axes 9a and 9b of the mixing tools 8a, 8b are spaced so far apart from one another in the direction of travel F that the operating circles A of the two mixing tools 8a, 8b do not quite overlap.

Apart from the mixing tool 8a at the front in the direction of travel F (the front end of the mixer 1 is also determined by the position of the tow bar), there is at least one side discharge opening 10, which is closed by a slide 11. In the illustrated embodiment two discharge openings 10 are provided, which are arranged at the height of the rotating axis 9a and are situated diametrically opposite on both sides of the rotating axis 9a, penetrating the wall 5.

During the operation of the mixer 1 according to the invention, the mix material is introduced into the mixing chamber 4 via the opening 7 and is transported upwards by the two vertical screws rotating in the same direction, it falls downwards again at the upper end of the vertical screws and is furthermore transferred from one vertical screw to the other, whereby mix material which reaches an opened discharge opening 10 due to this movement, is discharged continuously by it.

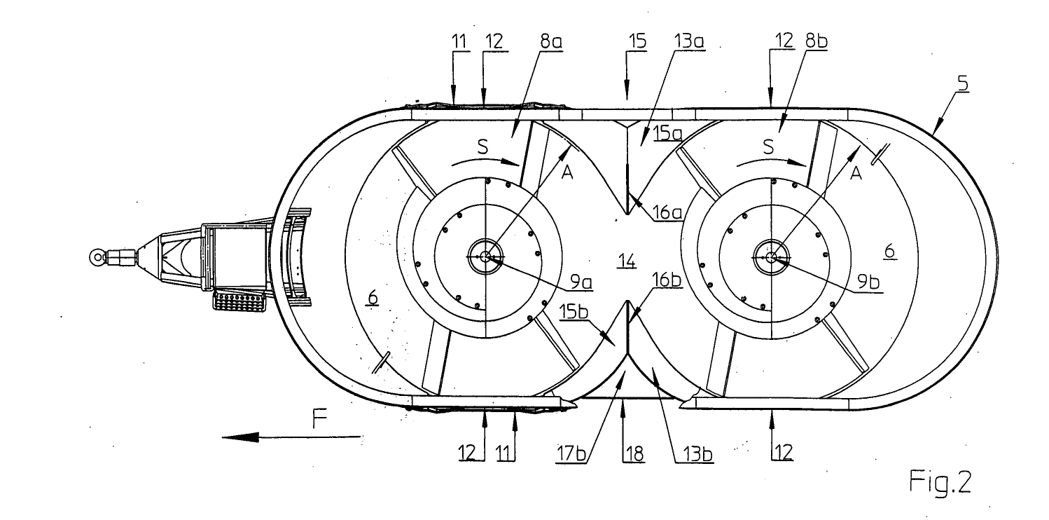

As a comparison with FIG. 2 shows, the transition between the wall 5 and the bottom 6 follows the curve of the operating circle A, i.e. the transition between the bottom and wall is curved with a radius which is essentially the same or slightly larger than the radius of the operating circle A, so that the mixing tool 8a or 8b can rotate without restriction over the bottom 6, but hardly any mix material remains lying on the bottom 6 between the wall 5 and the mixing tool 8a or 8b.

The wall 5 extends in the front and rear regions of the container 3 diagonally upwards and outwards so that the filling opening 7 is larger than the outline of the bottom 6. The slope angle of the wall 5 is largest in the extension of a joining line between the rotating axes 9a, 9b, which runs parallel to the direction of travel F and reduces with increasing distance from this joining line up to a triangular flattened area 12a, 12b positioned at the side, which is flat with its tip touching the bottom 6 and essentially extends perpendicular to the bottom 6. Due to the flattening 12, the width of the container 2 is reduced laterally to the direction of travel F so far that narrow stable alleys can be negotiated.

In the central region of the mixing chamber 4, where the two operating circles A of the two mixing tools 8a, 8b approach one another, the gusset regions 13a, 13b are formed (FIG. 2). Also in these side gusset regions the wall 5 at the transition to the bottom 6 follows the curve of the operating circle A, and in fact so far that on both sides of a line joining the two rotating axes 9a, 9b an opening 14 remains, by means of which mix material can be transported to and fro between the two mixing tools 8a, 8b. The wall 5 consequently follows the curvature of the operating circle A over more than half its circumference, whereby the opening 14 exhibits a width sufficient for an unrestricted transfer of the mix material and preferably reaches approximately more than one third of the cross-sectional area at this point.

In both gusset regions the wall 5 forms a guide device 15, which in the illustrated embodiment comprises two symmetrical guide tapers 15a and 15b forming an intersecting edge 16a, 16b, the said guiding tapers being formed and dimensioned identically and flanking the opening 14 on both sides. The wall slope is again increased with increasing distance from the flattened area 12 to form these guide tapers 15a, 15b.

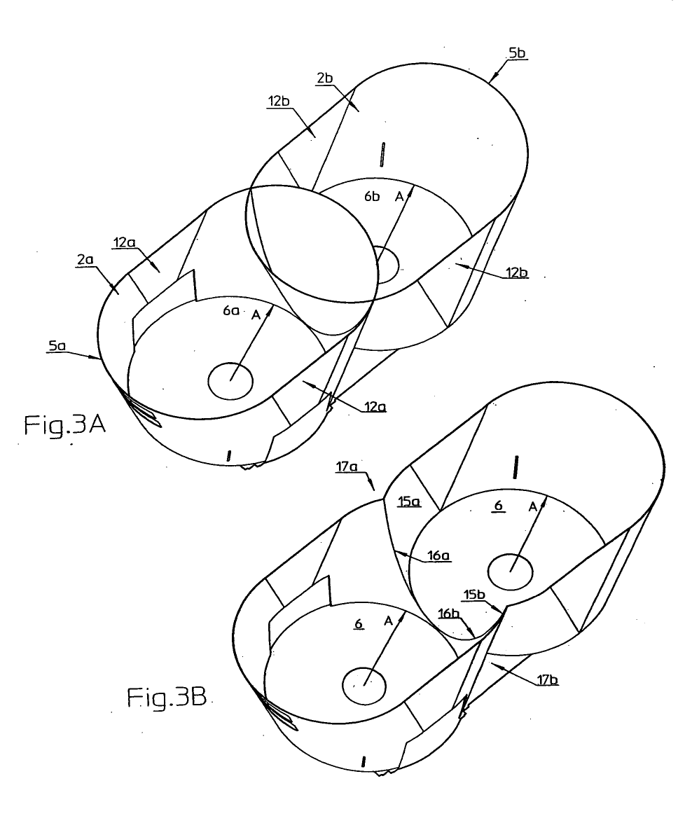

The design principle of the wall 5 of the container 2 is explained in more detail based on FIGS. 3A and 3B. The starting points are two imaginary, identical single containers 2a and 2b, each of which comprises a bottom 6a, 6b, an operating circle A projected on the bottom and a wall 5a and 5b. At the transition to the respective bottoms 6a, 6b, the walls 5a, 5b follow the curvature of the operating circle A, i.e. they are curved with a radius which is essentially equal to or slightly larger than the radius of the operating circle A. The walls 5a, 5b are provided respectively with matching, side flattened areas 12a and 12b, which run essentially perpendicular to the bottoms 6a, 6b, are curved outside of the flattened areas 12a, 12b and extend diagonally upwards and outwards outside of the flattened areas with a slope angle from the bottom 6a, 6b, the said slope angle becoming larger with increasing distance to the flattened areas 12a, 12b.

These two single containers 2a, 2b are then combined to form the container 2 in that the two single containers 2a, 2b are virtually brought together or into each other in the direction of the line joining the screw axes so far that the operating circles A in one of the areas with the largest slope of the wall 5 do not quite overlap and the walls 5a, 5b in this region can be regarded as penetrating or intersecting. Then to form the transfer opening 14, each region of the wall 5a and 5b beyond the penetration or intersection line is removed, so that the guide tapers 15a and 15b are formed symmetrically on both sides of the penetration line, whereby the penetration line or intersecting edge remains as a curved apex line 16a and 16b of the respective guide tapers 15a, 15b.

Due to the fact that the wall 5 of the complete container 2 follows the curve of the respective operating circles up to the transfer opening 14, an indentation 17a, 17b forms on the outer side of the wall 5 in the gusset regions 13a, 13b respectively which can be closed by a cover 18 (e.g. FIG. 1). It is furthermore possible to provide the bottom 6 also beneath the guide tapers 15a, 15b so that neither of the single containers 2a, 2b exhibits a partially circular shaped bottom.

The discharge openings 10 extend in their width in the illustrated embodiment over a flattened area 12a, 12b and on both sides of the flattened area through into the curved and sloped regions of the wall 5. For closing each discharge opening 10, a slide 11 is provided which essentially corresponds to the part of the wall 5 in its shape and constructive development which was removed from the wall 5 to form the discharge opening 10. In particular, the slide 11 exhibits a flattened region 11a as well as the curved wall regions 11b arranged on both sides of the flattened region, the said wall regions in their lower regions similarly following the curve of the operating circle A in the arrangement of the discharge opening 10 directly at the transition to the bottom 6. In this way, dead corners in which mix material could remain are avoided in the region of and adjacent to the discharge opening 10.

On both sides the slide 11 runs in guides 19a, 19b which are provided in the curved regions of the wall 5 on both sides of the flattened area 12a, 12b. The guides 19a, 19b are fitted such that they move the slide 11 during its movement upwards for opening the discharge opening 10 at a slope angle which approximately corresponds to the slope angle of the wall 5 in the region of the guides 19a, 19b. The slide 11 is moved via an actuating means 20 which is preferably an optionally similarly sloped piston/cylinder unit.

The construction and method of how the slide 11 is moved has already been described in DE-GM 203 14 002 for a mixer with a single vertical screw, which has not been the subject of prior publication, the disclosure content of which is included herewith for reference.

Due to the design according to the invention with the drawn-in wall, curved inwards in the gusset region between adjacent operating circles of mixing tools, it is ensured that the curved slide described which avoids dead corners can also be used in mixers with more than one mixing tool without problems arising in fitting the guide 19a which is situated closer to the centre to the same sloping and curved wall section as the oppositely situated guide 19b which is situated closer to the end of the container. It is pointed out that with conventional mixers, for example according to EP 1 175 828, a non-curved, essentially vertically extending wall runs at that point at which the guide 19a is located in the embodiment according to FIG. 1.

In the illustrated embodiment according to FIGS. 1 to 3 the guide tapers 15a, 15b extend up to the filling opening 7, i.e. up to the upper edge of the wall 5, whereby a small triangle 21 on which mix material can remain is formed in each case at the upper edge of the wall 5. In addition covering this triangle 21 is constructively complicated.

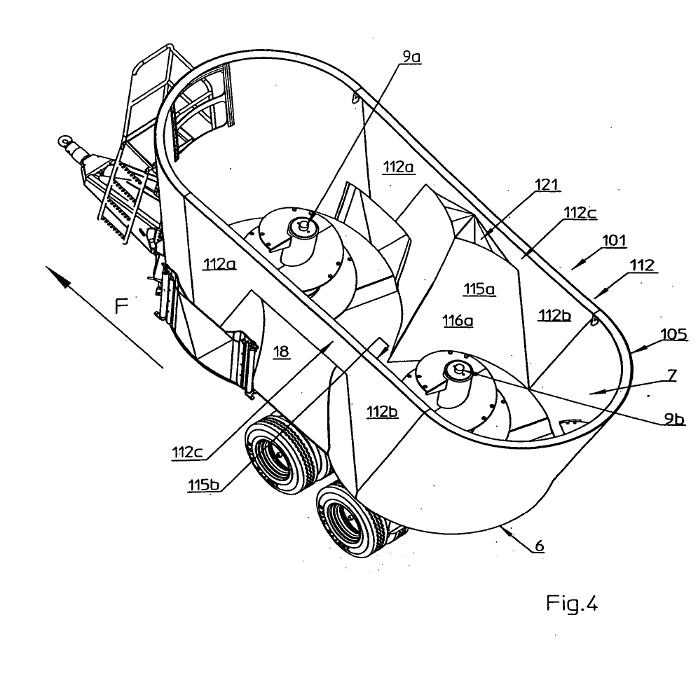

To avoid this, FIG. 4 shows another embodiment of a mixer 101 according to the invention, which is identical to the mixer according to FIG. 1 except for the following described details, whereby the same or comparable components are labelled with the same reference symbols and are not explained again.

The mixer 101 exhibits a wall 105 which is flattened to the side, whereby each side flattening 112 is formed in the direction of travel F to the right and left of the respective rotating axes 9a, 9b with a triangular region 112a, 112b. The tips of the triangular regions are situated at the transition to the bottom 6, whereas the bases of the triangular regions form the upper edge of the wall 105 at the filling opening 7. The triangular regions 112a, 112b are here joined together by means of a web 112c, whereby the web also forms the upper boundary of the wall 105 and joins the two triangles 112a, 112b in a straight line along their bases.

The wall 105 is, analogous to the first embodiment, curve-shaped and drawn inwards in the gusset region between the two operating circles and forms the guide device in the form of two symmetrical guide tapers 115a and 115b (hidden). The guide tapers 115a, which are formed by the wall 105, terminate here approximately in the region of the web 112c and are covered there with a covering taper 121, which in the usual manner as shown in the drawing, is composed of various straight sheet triangles and has its tip below the upper edge. Also with this embodiment, the boundary walls of the guide tapers 115a, 115b are curved and sloped analogous to the wall 105, whereas the apex line 116a, 116b, which also forms the line of symmetry for the guide tapers 115a, 115b, follows a penetration line of two single containers similar to FIGS. 3A, 3B.

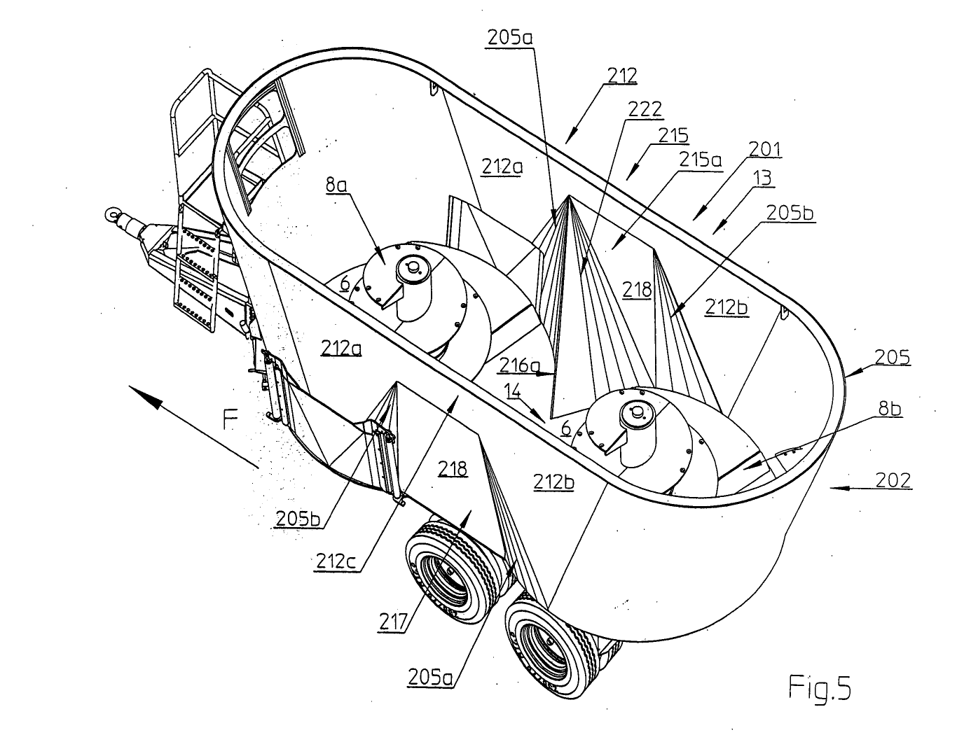

FIG. 5 shows another embodiment of a mixer 201 according to the invention, which corresponds to the mixers 1 and 101 except for the following described details, whereby the same reference symbols are used for the same or comparable components and they are not explained again.

The mixer 201 differs from the mixer 1 due to a different design of its guide devices 215. The wall 205 of the mixer 201 includes flattened areas 212 arranged at the side, which also in this embodiment in each case exhibit a front and a rear triangular region 212a and 212b and a joining web 212c as has also been described in the embodiment according to FIG. 4.

The guide device 215 in the gusset region 13 between the two operating circles A contains however asymmetrical guide tapers, of which only the guide taper 215a is illustrated, whereas the oppositely situated guide taper in the drawing is hidden, but is identical and formed as a mirror image. The guide taper 215a, which is described on behalf of both guide tapers, follows the curve of the operating circle A at the transition to the bottom 6 in the same manner as has already been described in the previous embodiments. Adjoining the respective triangular regions 212a and 212b of the flattened area 212, specially shaped wall regions 205a, 205b are provided which lead to the gusset region 13 and have been formed as in the previous embodiments by a curved and/or sloping design of the wall 205 of the respective single containers, so that the indentation 217b (217a hidden) already described is formed on the outside of the container 202. The indentation 217 is terminated by a cover 218, which is formed as a flat panel, which extends upwards to the web 212c of the flattened area 212 and which is fitted sloping diagonally inwards. The wall region 205a, respectively 205b, which is assigned to the right rear mixing tool 8b or to the left front mixing tool 8a, terminates at this cover 218. The wall region 205b, which is shown in FIG. 5 as an internal view, is approximately triangular and concave, whereby the base is situated at the transition to the bottom 6 and one leg is bounded by the rear, triangular flattened area 212b and the second leg is bounded by the edge of the cover 218 which points backwards. At the contact point of the wall surface 205b with the bottom 6 begins a second guiding surface 222, similarly essentially triangular and optionally concave, the base of which at the transition to the bottom 6 follows the curve of the operating circle of the rear, resp. front mixing tool 8b, 8a, which however slopes flatter, i.e. more towards the front, than is the case with the wall region 205b. The guiding surface 222 is bounded by the cover 218 on the edge facing backwards and terminates with its tip below the upper edge of the transition between the front triangular region 212a of the flattened area 212 and the web 212c.

In the region of the front mixing tool 8a the wall region 205a can run through to the transfer opening 14 and meet the guiding surface 222 and form an apex line 216a of the guide taper 215. Alternatively, another surface, which at its base also follows the curve of the operating circle A of the front mixing tool 8a at the transition to the bottom 6, terminates at the wall surface 205a, but exhibits a slope to the bottom which deviates from the slope of the wall region 205a. The slope is preferably steeper as is also shown in FIG. 5. In this way the advantages of the design according to the invention can also be used for mixers which despite side transfer openings 14 are provided with asymmetrical guide tapers, as has been described e.g. in EP 1 175 828.

In a modification of the described and drawn embodiments, details of the embodiments can be exchanged one for the other. For example, it is possible to use asymmetrical guide tapers also with flattened areas without a web. The invention can also be used analogously on other types of mixer or on mixers with more than two mixing tools, whereby the wall can be drawn in as described between each of the mixing tools. The positions of the discharge openings are not restricted to the described positions, but rather other positions are possible as required. Also the mixing tools can be formed differently to those illustrated.

1. A mixer such as for a feed mixing truck, comprising:
a mixing chamber, which can be filled from above having a wall, and a bottom;
at least two rotating, drivable mixing tools arranged inside the mixing chamber, each of the said mixing tools covering an operating circle (A) projected on the bottom,
guides formed on said wall in the interior of the mixing chamber to leave a transfer opening in the gusset regions between the two operating circles (A),
wherein the wall at the transition to the bottom follows the curve of the respective operating circles (A) into the gusset region between the two operating circles (A) and the wall to form the respective guide device itself with or without a wall extension.

2. The mixer according to claim 1, wherein said wall has a discharge opening and further comprising a slide closure at the transition to the bottom having the shape of the curve of the operating circle (A).

3. The mixer according to claim 2, further comprising side guides, on at least one of the curved sections of the wall for guiding said slide.

4. The mixer according to claim 1 wherein said wall follows the curve of the two adjacent operating circles (A) up to said transfer opening at the transition from one said mixing tool to the adjacent mixing tool to form a symmetrical guide taper.

5. The mixer according to claim 1 wherein said wall in the gusset region is joined to an extension for forming an asymmetrical guide taper and said extension at the transition to the bottom follows the curve of the operating circle (A).

6. The mixer according to claim 1 wherein said wall in the gusset region is curved inwards and forms an indentation on the outside of the mixing chamber.

7. The mixer according to claim 6, further comprising a cover for covering said indentation.

8. The mixer according to claim 1 wherein:
said bottom is essentially circular shaped in the region of each operating circle (A) up to more than half of its circumference,
said wall at the transition to the bottom is curved in a circular arc and slopes from the bottom diagonally upwards and outwards, and
said wall is provided on each side with a flattened area, which runs parallel to a tangent to the operating circle (A) of the respective mixing tool and is bounded on both sides by curved regions of said wall.

9. The mixer according to claim 8, wherein two flattened areas are assigned to adjacent operating circles (A) and are joined together in the upper region of the wall by a web.

10. The mixer according to claim 1 wherein said wall is constructed of at least two single containers each with a bottom and a wall, whereby said wall of each said single container is curved around an operating circle, slopes from the bottom upwards and outwards to form a filling opening, and is enlarged with respect to the bottom, and is provided with a side flattened area,
whereby said walls of said at least two separate containers intersect one another such that the respective operating circles (A) do not quite overlap; and
wherein a respective guide formed in the gusset region by means of the wall with or without an extension, leaving free a transfer opening.

11. The mixer according to claim 2 wherein said wall follows the curve of the two adjacent operating circles (A) up to said transfer opening at the transition from one said mixing tool to the adjacent mixing tool to form a symmetrical taper for a said guide.

12. The mixer according to claim 2 wherein said wall in the gusset region is joined to an extension for forming an asymmetrical guide taper and the extension at the transition to the bottom following the curve of the operating circle (A).

13. The mixer according to claim 2 wherein said wall in the gusset region is curved inwards and forms an indentation on the outside of the mixing chamber.

14. The mixer according to claim 2 wherein:
said bottom is essentially circular shaped in the region of each operating circle (A) up to more than half of its circumference,
said wall at the transition to the bottom is curved in a circular arc and slopes from the bottom diagonally upwards and outwards, and
said wall is provided on each side with a flattened area which runs parallel to a tangent to the operating circle (A) of the respective mixing tool and is bounded on both sides by curved regions of the wall.

15. The mixer according to claim 2 wherein said wall is constructed of at least two single containers each with a bottom and a wall, said wall of each said single container is curved around an operating circle, slopes from the bottom upwards and outwards to form a filling opening, and enlarged with respect to the bottom, and is provided with a side flattened area,
whereby said walls intersect one another such that the respective operating circles (A) do not quite overlap, and
wherein a respective guide formed in the gusset region by means of the wall with or without an extension, leaving free a transfer opening.
